(19) United States
(12) Patent Application Publication
(10) Pub. No.: US 2017/0318629 A1
(43) Pub. Date: Nov. 2, 2017

(54) Multifunction Ovens

(71) Applicant: Younes Mohseni, Boca Raton, FL (US)

(72) Inventor: Younes Mohseni, Boca Raton, FL (US)

(21) Appl. No.: 15/473,779

(22) Filed: Mar. 30, 2017

Related U.S. Application Data
(63) Continuation-in-part of application No. 14/297,600, filed on Jun. 5, 2014.

(51) Int. Cl. H05B 6/64; A47J 37/08

(52) U.S. Cl. CPC H05B 6/6482; A47J 37/0871

(57) ABSTRACT

A.

i. A toaster component is incorporated into a conventional countertop toaster oven to create a countertop Toaster Oven/Toaster combo, a single structure. The toaster and toaster oven components of this appliance can be used individually or both at the same time.

ii. A toaster component is incorporated into a conventional countertop microwave oven to create a countertop Microwave Oven/Toaster combo, a single structure. The toaster and microwave oven components of this appliance can be used individually or both at the same time.

iii. A toaster component is incorporated into a conventional over-the-range microwave oven to create an Over-The-Range Microwave Oven/Toaster combo, a single structure. The toaster and microwave oven components of this appliance can be used individually or both at the same time.

B.

i. A toaster oven is incorporated into the countertop Microwave Oven/Toaster combo, above A.ii, to create a countertop Microwave Oven/Toaster Oven/Toaster combo, a single structure. The toaster, toaster oven and microwave oven components of this appliance can be used individually, two or three at the same time.

ii. A toaster oven is incorporated into the Over-The-Range Microwave Oven/Toaster combo, above A.iii, to create an Over-The-Range Microwave Oven/Toaster Oven/Toaster combo, a single structure.

The toaster, toaster oven and microwave oven components of this appliance can be used individually, two or three at the same time.

### BACKGROUND OF THE INVENTION

The counter space and storage required for a standard “toaster”¹, a standard “toaster oven²” and a standard “countertop microwave oven³”/a standard “over-the-range microwave oven⁴” has been two issues for a) homes and apartments with small kitchens and b) studio apartments and dormitories with no kitchen.

The “Multifunction Ovens” have been designed to replace several small kitchen appliances into a single unit and therefore eliminate the counter space and storage problems. The “Multifunction Ovens” will save consumers money by purchasing a single multifunction unit instead of multiple single-function units,

Additionally, by combining the heat generated by microwave oven radiation and the heat generated by toaster oven infrared radiation the food cooks faster and looks and tastes better.

The “Multifunction Ovens” will have the greatest impact in congested major cities around the world where having a small kitchen is a norm. And regardless of a kitchen size and its counter and storage space, these products prevent clutter and are aesthetically more appealing.

### BRIEF SUMMARY OF THE INVENTION

By combining two and three of the “standard toaster”, “standard toaster oven”, “standard countertop microwave oven” and “standard over-the-range microwave oven”, the following five new products will emerge:

1. “Multifunction Toaster Oven”, which combines⁵ a “standard toaster” and a “standard toaster oven” into a single unit.

2. “Multifunction Microwave Oven-A1”, which combines⁵ a “standard toaster” and a “standard countertop microwave oven” into a single unit.

3. “Multifunction Microwave Oven-A2”, which combines⁵ a “standard toaster” and a “standard over-the-range microwave oven” into a single unit.

4. “Multifunction Microwave Oven-B1”, which combines⁵ a “standard toaster”, a “standard toaster oven”, and a “standard countertop microwave oven” into a single unit.

5. “Multifunction Microwave Oven-B2”, which combines⁵ a “standard toaster”, a “standard toaster oven” and a “standard over-the-range microwave oven” into a single unit.

In addition to toasting bread, the “toaster component” of any of the above products can be used to warms up, broil, bake and toasts steaks, sliced egg plant, potato, squash, hotdogs, various sizes of pizza, among others, which are impossible tasks for a standard toaster or any similar product to achieve. Additionally, by switching the “wire rack” with a “griddle”, consumers can cook eggs, pancakes, cookies, etc. as well.

The five multi-function appliances described above maintain the “utility”, “full capacity”, “full functionality”, “ease of use”, “appearance⁶” and “safety” of the individual standard appliances they replace.

Existing materials, processes, manufacturing and technology can be used to manufacture these “Multifunction Ovens”.

### BRIEF DESCRIPTION OF THE DRAWING VIEWS

FIG. 1A, on page 1/8: Shows overall Design Concept with “drawer assembly”, Item 17, in open position,

Item 10 depicts any of the “Multifunction Ovens”, with two cavities. (The larger cavity represents the cavity of a standard “toaster oven”, a standard “countertop microwave oven” or a standard “over-the-range microwave oven” and the smaller cavity represents the space where the “toaster component” is housed.)

Item 11 depicts the larger “cooking cavity” of the appliance,

Item 12 depicts the “toaster component” assembly and its location,

Item 13 depicts the “toaster component” cavity (i.e. the shell), part of the “toaster component” assembly,

Item 14 depicts the “top heat source”, part of “toaster component” assembly (the vertical line represent the Nichrome wires and spacing between each run),

Item 15 depicts the “bottom heat source”, part of “toaster component” assembly (the vertical line represent the Nichrome wires and spacing between each run),

Item 16 depicts the “door” of any of above said ovens' main cavity,

Item 17 depicts the “drawer assembly”, part of the “toaster component” assembly,⁷

Item 18 depicts the “front panel assembly”, part of “drawer assembly”,

Item 19 depicts the “wire rack”, part of “drawer assembly”,

Item 20 depicts the “tray”, part of “drawer assembly”,

Item 21 depicts the “drawer assembly release mechanism”, part of “toaster component” assembly.

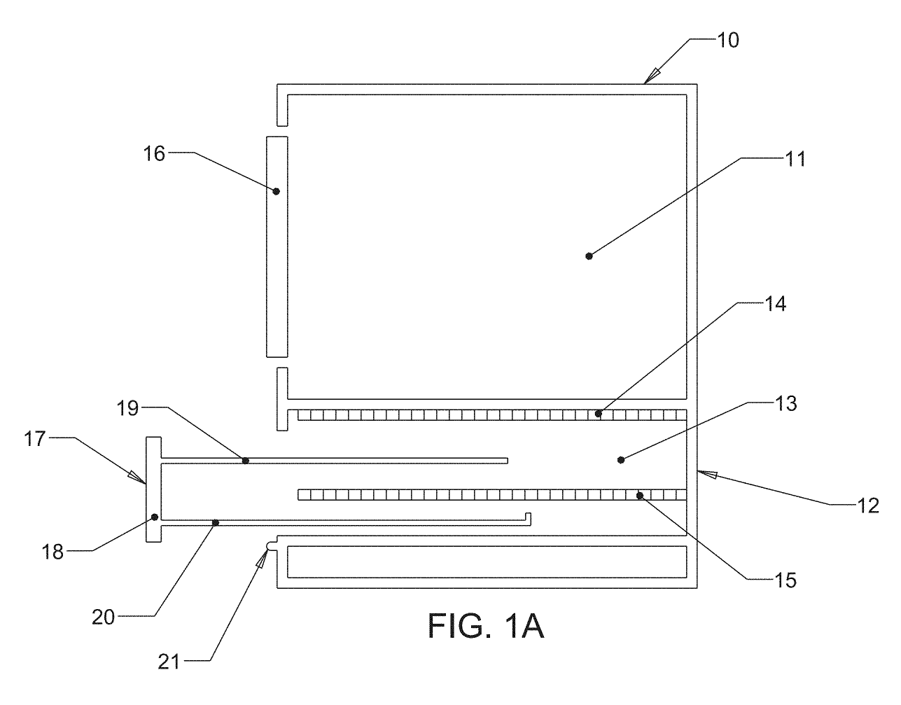

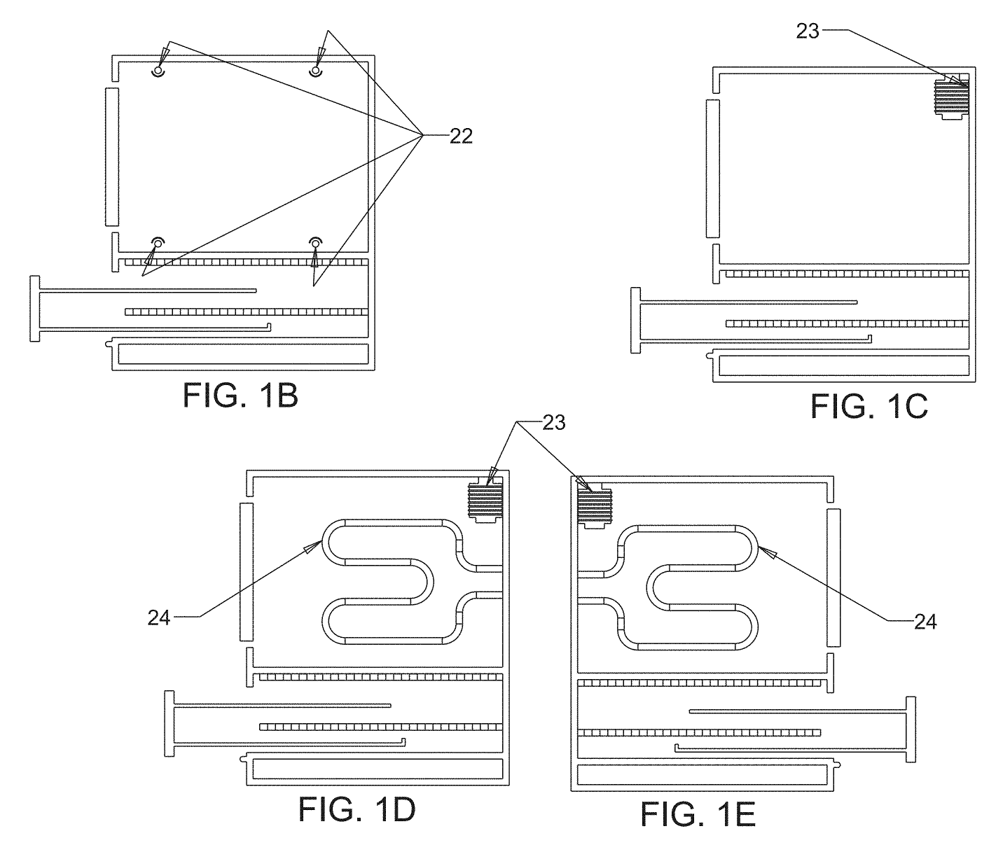

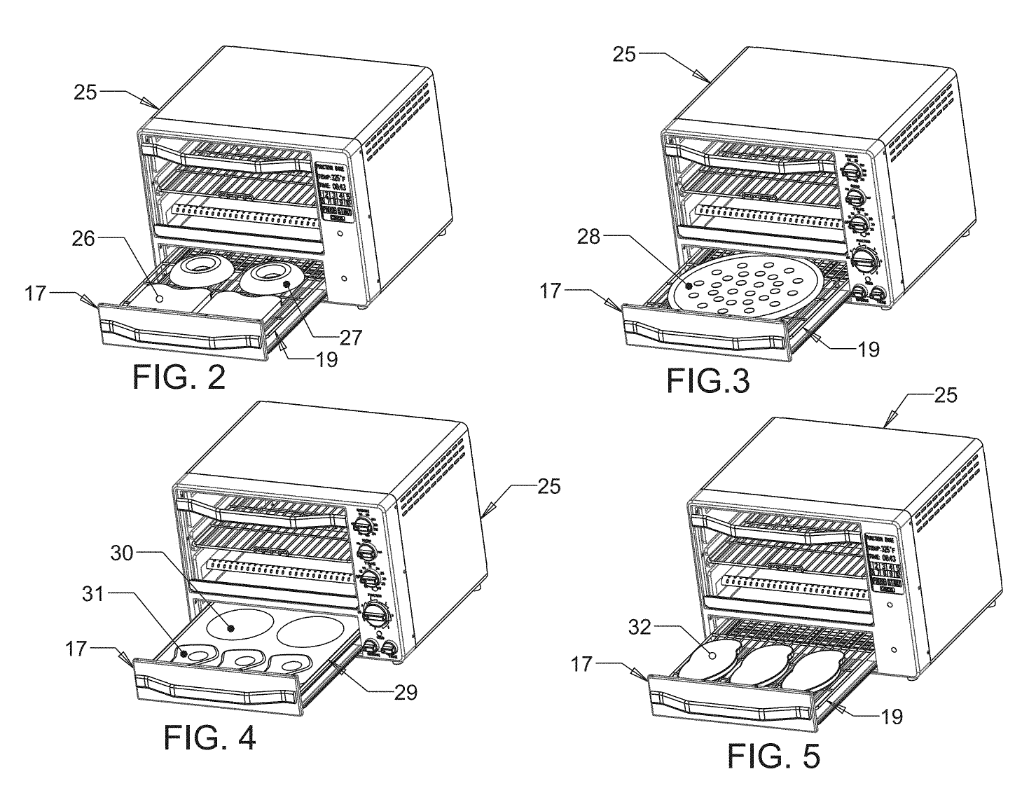

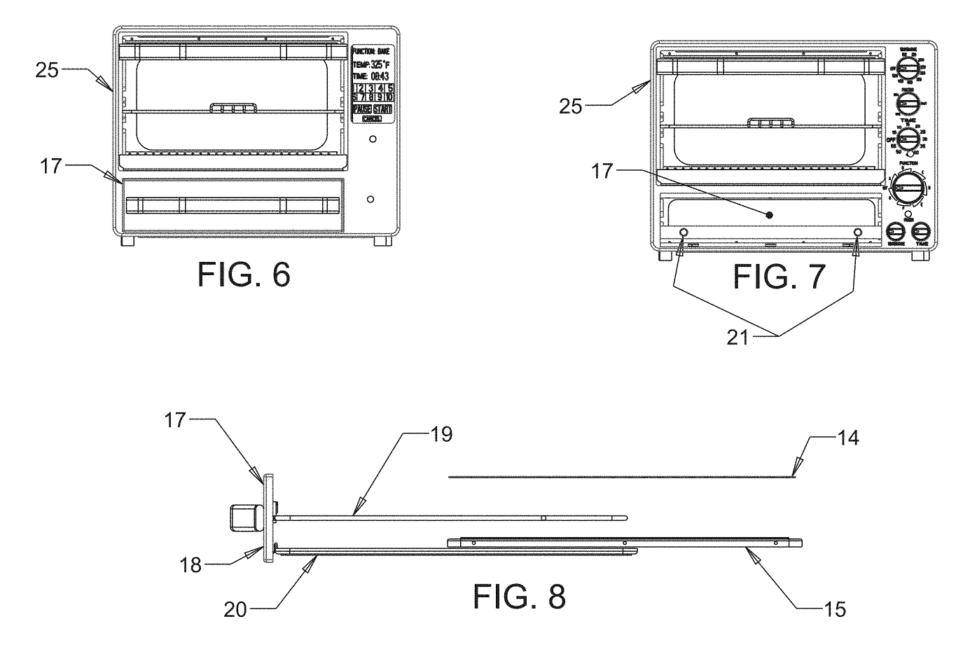

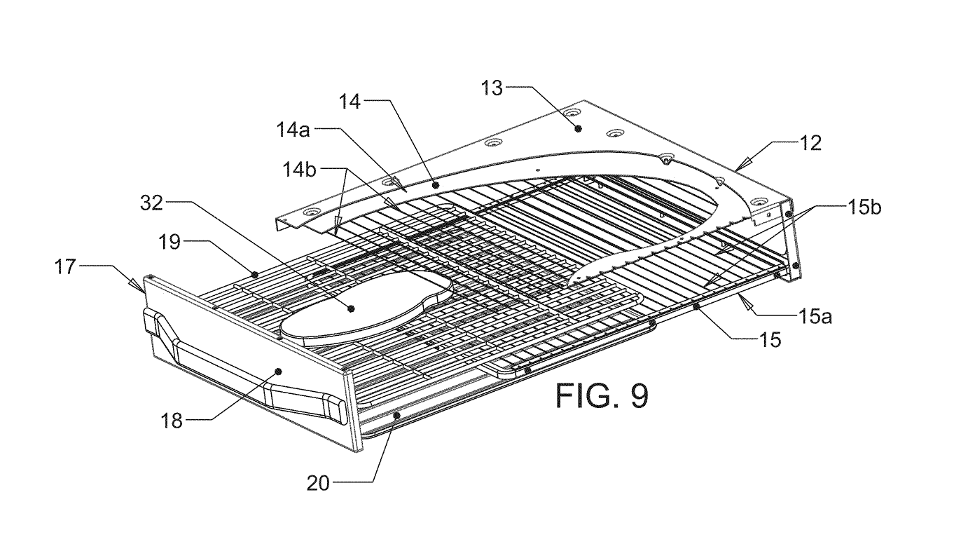

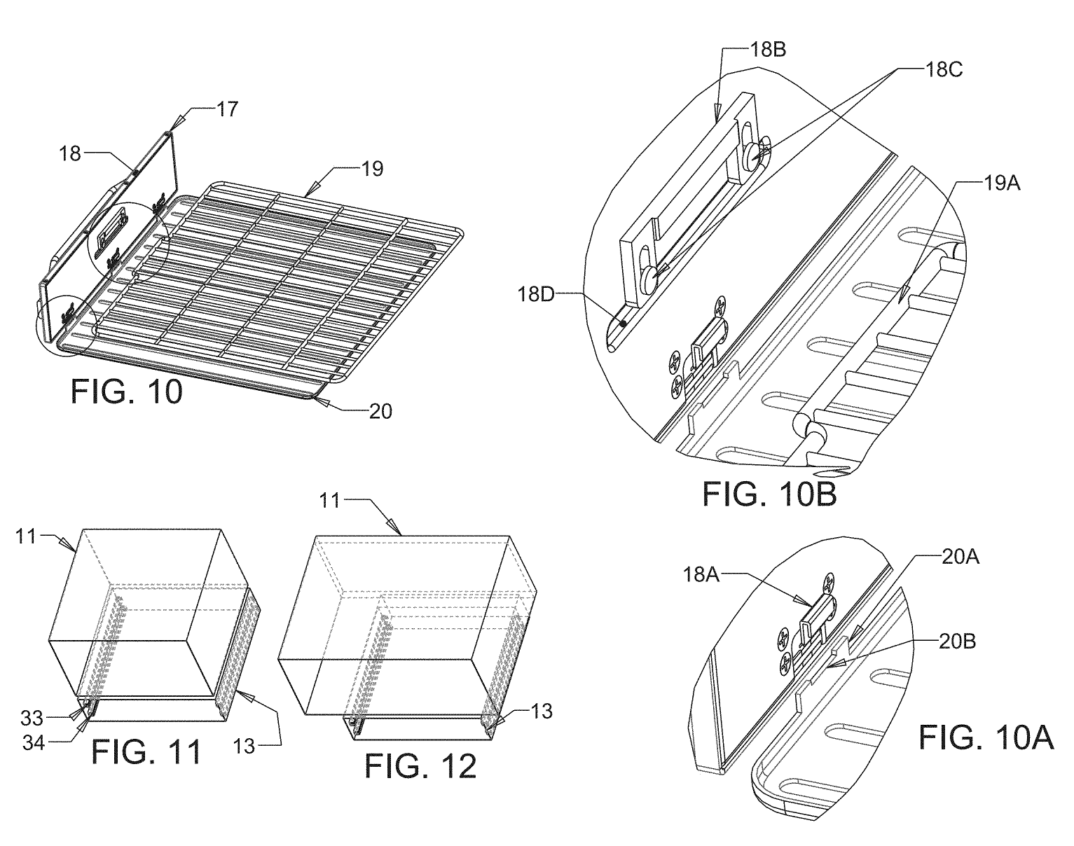

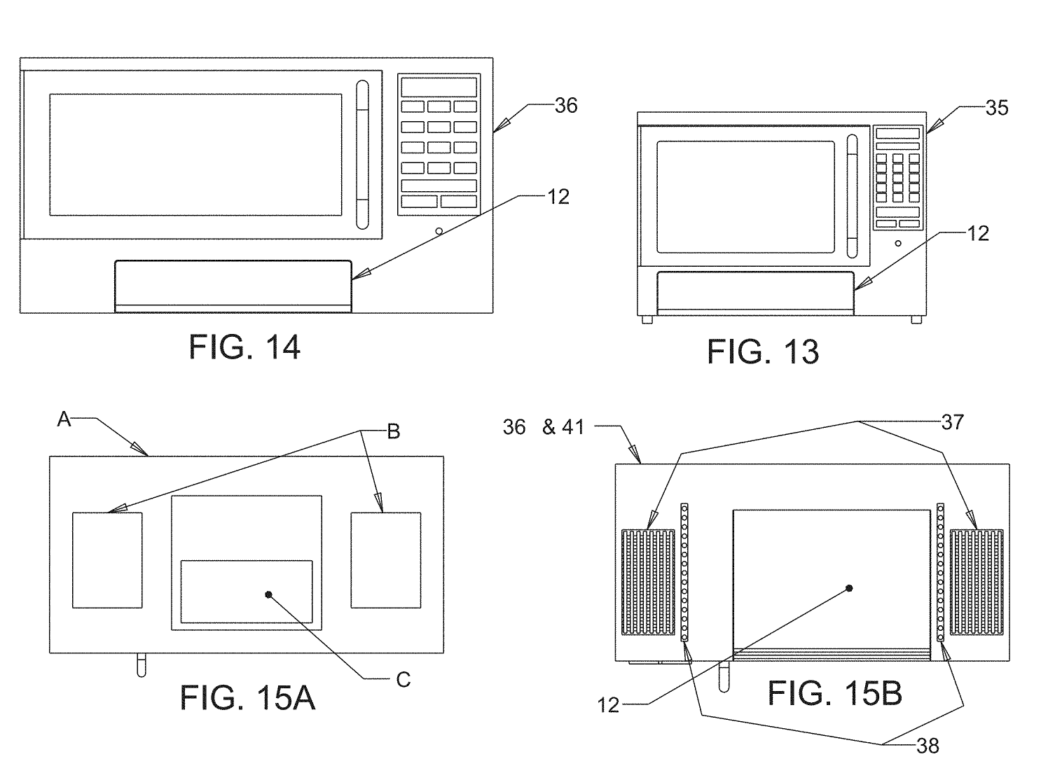

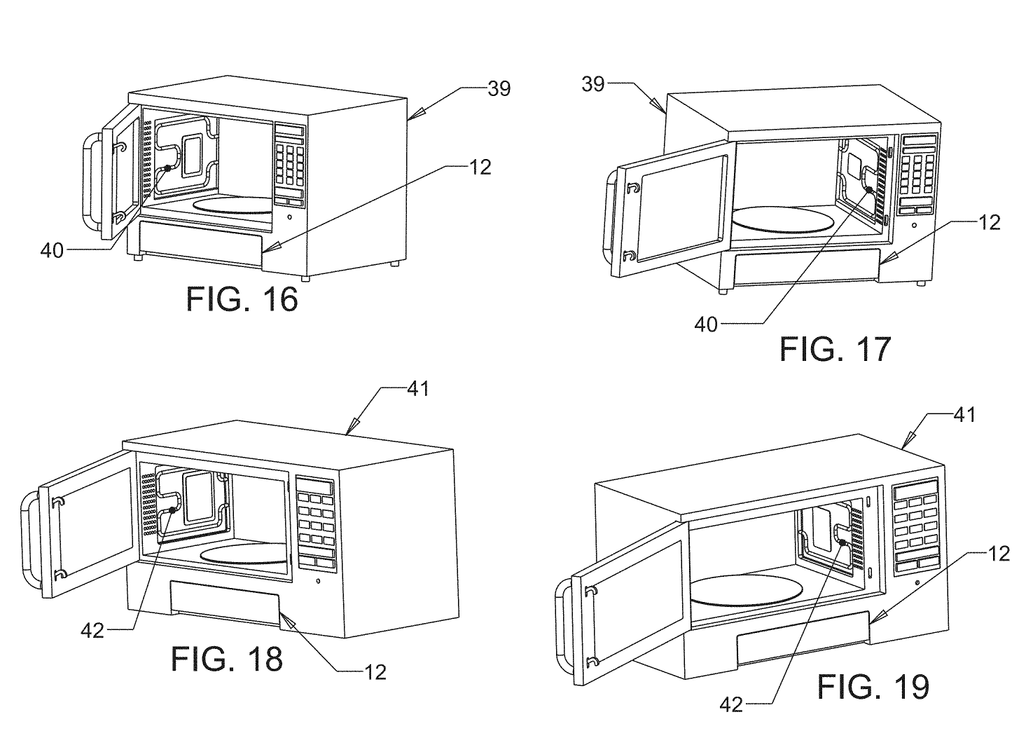

FIG. 1B, on page 2/8: Depicts the cross section of a “Multifunction Toaster Oven” with Item 22 representing the heating elements for toaster oven portion of the appliance.

FIG. 1C, on page 2/8: Depicts the cross section of a “Multifunction Microwave Oven-A1”/“Multifunction Microwave Oven-A2” with item 23 representing the magnetron for the microwave portion of the appliance.

FIG. 1D, on page 2/8: Depicts the cross section of a “Multifunction Microwave Oven-B1”/“Multifunction Microwave Oven-B2” with Item 24 representing the heating element on the left sidewall of the main cavity and Item 23 representing the magnetron indicating the dual usage (toaster oven and microwave oven) of the main cavity of the same appliance.

FIG. 1E, on page 2/8: Same as FIG. 1D except it depicts the right sidewall of the main cavity of the same appliance.

FIG. 2, on page 3/8: Isometric view of “Multifunction Toaster Oven”, Item 25, with digital control panel pointing to the “Drawer Assembly”, Item 17, in open position, breads, Item 26, and bagels, Item 27.

FIG. 3, on page 3/8: Isometric view of the “Multifunction Toaster Oven”, Item 25, with analog control panel pointing to the “Drawer Assembly”, Item 17, in open position and pizza, Item 28.

FIG. 4, on page 3/8: Isometric view of the “Multifunction Toaster Oven”, Item 25, with analog control panel pointing to the “Drawer Assembly”, Item 17, in open position, pancakes/cookies, Item 30, and eggs, Item 31 on a “Griddle”, Item 29.

FIG. 5, on page 3/8: Isometric view of the “Multifunction Toaster Oven”, Item 25, with digital control panel pointing to the “Drawer Assembly”, Item 17, in open position and steaks, Item 32.

FIG. 6, on page 4/8: Front view of the “Multifunction Toaster Oven”, Item 25, with digital control panel pointing to the “Drawer Assembly”, Item 17, in closed position.

FIG. 7, on page 4/8: Front view of the “Multifunction Toaster Oven”, Item 25, with digital control panel; the “Drawer Assembly” is removed to display the optional “drawer assembly release mechanism” arms and locations pointing to “Toaster Component” assembly, Item 12.

FIG. 8, on page 4/8: Right view of the “toaster component” with “toaster component cavity” removed for clarity, displaying its major parts, “Drawer Assembly”, Item 17, “Top Heat Source”, Item 14 and “Bottom Heat Source”, Item 15.

FIG. 9, on page 5/8: Isometric view of the “Toaster Component”, with the “Drawer Assembly” in open position and complete floor, right & left sidewalls and partial top side of the “Toaster Component Cavity” removed to display all the parts including “Mica sheet”, Item 14a, and “Nichrome wire”, Items 14b & 15b.

FIG. 10, on page 6/8: Isometric and exploded view of the “Drawer Assembly”, Item 17, displaying the “Front Panel Assembly”, Item 18, “Wire Rack”, Item 19 and “Tray”, Item 20.

FIG. 10A, on page 6/8: Displays detail view of the mechanism attaching the “front panel assembly”, Item 18, to “Tray”, Item 20, where bent U-shaped sections, Item 18A, (part of “front panel assembly”) slide and rest over the notch, Item 20B, in the ear, Item 20A, on the “Tray” and locks the two pieces together.

FIG. 10B, on page 6/8: Displays detail view of the mechanism attaching the “front panel assembly”, Item 18, to the “Wire Rack”, Item 19, where a slide, Item 18B, (part of “front panel assembly”) moves up to allow the bump”, Item 19A, at the front and center of the “Wire Rack nestles in the cavity, Item 18D, and then moves down and locks the two pieces together. Item 18C is a shoulder screw.

FIG. 11, on page 6/8: Isometric view of the “Toaster Component Cavity”, Item 13, and any of the main oven cavities displaying the “steps” on the “toaster component cavity” sidewalls.

FIG. 12, on page 6/8: Same as FIG. 11; but it displays the narrower width of the “Toaster Component Cavity”, Item 13, in comparison to the larger width of the main cavity of the “over-the-range microwave oven”.

FIG. 13, on page 7/8: Front view of the “Multifunction Microwave Oven-A1”, Item 35, pointing to the “Drawer Assembly”, Item 12.

FIG. 14, on page 7/8: Front view of the “Multifunction Microwave Oven-A2”, Item 36, pointing to “Drawer Assembly”, Item 12.

FIG. 15A, on page 7/8: Bottom view of a “Conventional Over-The-Range Microwave Oven”, Item A, displaying typical locations of the two “vents/filters”, Item B, and single “light fixture”, Item C.

FIG. 15B, on page 7/8: Bottom view of “Multifunction Microwave Oven-A2”, Item 36, OR “Multifunction Microwave Oven-B2”, Item 41, displaying the new locations of “vents/filters”, Item 37,“light fixtures”, Item 38, after incorporation of the “Toaster Component”, Item 12.

FIG. 16, on page 8/8: Isometric view of “Multifunction Microwave Oven-B1”, Item 39, displaying the “Drawer Assembly”, Item 12, and the left sidewall “Heating Element, Item 40.

FIG. 17, on page 8/8: Isometric view of “Multifunction Microwave Oven-B1”, Item 39, displaying the “Drawer Assembly”, Item 12, and its right sidewall “Heating Element”, Item 40.

FIG. 18, on page 8/8: Isometric view of “Multifunction Microwave Oven-B2”, Item 41, displaying the “Drawer Assembly”, Item 12, and its left sidewall “Heating Element”, Item 42.

FIG. 19, on page 8/8: Isometric view of “Multifunction Microwave Oven-B2”, Item 41, displaying “Drawer Assembly”, Item 12, and its right side wall “Heating Element”, Item 42.

### DETAILED DESCRIPTION OF THE INVENTION

A re-configured “standard toaster” with “wide, deep and short” body, “toaster component” (Item 12 of FIG. 1A), is integrated into the following three standard products: a “toaster oven”, a “countertop microwave oven” and an “over-the-range microwave oven” to create the following five new small kitchen appliances: i) “Multifunction Toaster Oven”, which combines⁵ a “conventional toaster” and a “conventional toaster oven”, ii) “Multifunction Microwave Oven-A1”, which combines⁵ a “conventional toaster” and a “conventional countertop microwave oven”, iii) “Multifunction Microwave Oven-A2”, which combines⁵ a “conventional toaster” and a “conventional over-the-range microwave oven”, iv) “Multifunction Microwave Oven-B1”, which combines⁵ a “conventional toaster”, a “conventional toaster oven” and a “conventional countertop microwave oven” and, v) “Multifunction Microwave Oven-B2”, which combines⁵ a “conventional toaster”, a “conventional toaster oven” and a “conventional over-the-range microwave oven”.

This “toaster component”, Item 12 of FIG. 1A and FIG. 9, is an integral part of all five NEW products emerging from these designs and is located underneath their main ovens' cavities. It is composed of four major components: the “toaster component cavity”, Item 13 of FIG. 9 and FIG. 11, the “top heat source”, item 14 of FIG. 1A and FIG. 8, the “bottom heat source”, Item 15 of FIG. 1A and FIG. 8 and the “drawer assembly”, Item 17 of FIG. 1A and FIG. 8.

The “width, depth and height” of the “toaster component cavity”, Item 13 of FIG. 9 and FIG. 11, in all designs are the same as the main oven cavities, except for when it's integrated into the “over-the-range microwave ovens”, the “Multifunction Microwave Oven-A2” and “Multifunction Microwave Oven-B2”.

Due to the space requirement for “vents/filters” and “light fixtures” on the bottom surface of the “over-the-range microwave oven”, the “width” of the “toaster component cavity”, Item 13 of FIG. 12, is narrower than that of the main cavity of the “over-the-range microwave oven”.

The “Multifunction Toaster Oven”, Item 25 of FIG. 2 through FIG. 7, is composed of a “toaster component”, Item 12 of FIG. 1A, and a “standard toaster oven component” which uses the larger cavity.

The “Multifunction Microwave Oven-A1”, Item 35 of FIG. 13, is composed of a “toaster component”, Item 12 of FIG. 1A, and a “standard countertop microwave oven component” which uses the larger cavity. The “Multifunction Microwave Oven-A2”, Item 36 of FIG. 14, is composed of a “toaster component”, Item 12 of FIG. 1A, and a “standard over-the-range microwave oven component” which uses the larger cavity.

The “Multifunction Microwave Oven-B1”, Item 39 of FIG. 16 and FIG. 17, is composed of a “toaster component”, Item 12 of FIG. 1A, a “standard toaster oven component” and a “standard countertop microwave oven component”. The “standard toaster oven component” and the “standard countertop microwave oven component” both share the same large cavity, Item 11 of FIG. 1A.

The “Multifunction Microwave Oven-B2”, Item 41 of FIG. 18 and FIG. 19, is composed of a “toaster component”, Item 12 of FIG. 1A, a “standard toaster oven component” and a “standard over-the-range microwave oven component”. The “standard toaster oven component” and the “standard over-the-range microwave oven component” both share the same large cavity, Item 11 of FIG. 1A.

The “toaster component”, Item 12, accommodates multiple pieces of breads, sliced egg plants, potatoes, squashes, steaks, hotdogs and various sizes of pizzas among other food items. Additionally, by switching the “wire rack”, Item 19 of FIG. 10, with the “griddle”, Item 29 of FIG. 4, the “toaster component” can be used to make eggs, pancakes and cookies as well.

The “toaster component”, Item 12, is composed of four major parts:

1. The “Toaster Component Cavity”

The “toaster component cavity”, Item 13 of FIG. 9, FIG. 11 and FIG. 12, a metal shell, is the space which houses the “top heat source top”, Item 14 of FIG. 8, “bottom heat source”, Item 15 of FIG. 8, and “drawer assembly”, Item 17 of FIG. 8. It is positioned below the larger cavity of the main unit (i.e. “toaster oven”/“microwave oven” cavity) horizontally and except for the “over-the-range microwave oven” it is as wide and deep as the main cavity.

2. “Top Heat Source”

The “top heat source”, Item 14 of FIG. 8, is composed of a large Mica sheet, Item 14a of FIG. 9, or any suitable insulating materials, and extruded Nichrome wire, Item 14b of FIG. 9, as heating element. Nichrome wire, Item 14b, runs throughout the bottom surface of the Mica sheet, Item 14a, with narrow spacing between each run to uniformly distribute the heat, duplicating the toasting function of heating element in a “standard toaster”. The “top heat source” is then attached to the ceiling of the “toaster component cavity”, Item 13 of FIG. 9. The “Mica sheet”, or any suitable insulating materials, insulates Nichrome wire, Item 14b, from the metal ceiling of the “toaster component cavity”, Item 13.

3. “Bottom Heat Source”

The “bottom heat source”, Item 15 of FIG. 8, is composed of a “rectangle metal frame”, Item 15a of FIG. 9, and extruded Nichrome wire, Item 15b of FIG. 9, as heating element. Items 14b and Item 15b of FIG. 9 are both “Nichrome wire”.

Nichrome wire, Item 15b, is run throughout the top surface of the “rectangle metal frame”, Item 15a, with narrow spacing between each run to uniformly distribute the heat, duplicating the toasting function of heating element in a “standard toaster”. Strips of Mica, or any suitable insulating materials, are used where needed to insulate Nichrome wire, Item 15b, from the frame, Item 15a. The “rectangle metal frame”, Item 15a, is attached to the walls of the “toaster component cavity”. Item 13. The “rectangle metal frame”, Item 15a, itself can be manufactured, entirely or partially, from non-conductive materials to eliminate Mica strips. The “rectangle metal frame”, Item 15a, can be replaced by 2 to 4 non-conductive bars functioning as a rectangle frame.

The “bottom heat source”, Item 15 of FIG. 8, is positioned under the “wire rack”, Item 19 of FIG. 8, and above the “tray”, Item 20 of FIG. 8. This allows the food particles and liquid (i.e. bread crumbs, meat juice/fat, pizza sauce/melted cheese, etc.) pass through the “bottom heat source”, Item 15, and get collected in “tray”, Item 20 of FIG. 8.

4. “Drawer Assembly”

The “drawer assembly”, Item 17 of FIG. 8-FIG. 10, is composed of the “front panel assembly”, Item 18, “wire rack”, Item 19, and “tray”, Item 20. The “drawer assembly”, Item 17, slides in and out of the “toaster component cavity”, Item 12, as a “single unit”. The simultaneous movement of “wire rack” and “tray” prevents the food particles and liquid (i.e. bread crumbs, meat juice/fat, pizza sauce/melted cheese, etc.) from scatter/spill on the kitchen counter.

The “wire rack”, Item 19, is where the food items are placed and “tray”, Item 20, is where the food particles and liquid get collected.

A “built-in” or a “standard handle” can be used to open or close the “drawer assembly”, Item 17, manually.

Four long steps, Item 33 and Item 34 of FIG. 11, on each of the “toaster component cavity”, Item 13, sidewalls are allocated for the support and movement of the “drawer assembly”, Item 17.

The “wire rack”, Item 19, is supported by and slides between the upper “steps”, Item 33, and the “tray”, Item 20, is supported by and slides between the lower “steps”, Item 34.

The “wire rack”, Item 19, and “tray”, Item 20, in “drawer assembly”, Item 17, can be disassembled and assembled quickly without any tools from the “drawer assembly”, Item 17, for cleaning purposes or switching from the “wire rack” to the “griddle” when eggs, pancakes and cookies are being cooked.

To remove the “tray”, Item 20, or the “wire Rack”, Item 19, for cleaning or switch from the “wire rack” to the “griddle”, Item 29 of FIG. 4, the “drawer assembly”, Item 17, is pulled out several inches from the closed position, the slide, Item 18B of FIG. 10B, on the “front panel assembly”, Item 18, is pulled up releasing the “wire rack”; the “wire rack” is then pushed back all the way in, disengaging its bump, Item 19A of FIG. 10B, from the “Front panel assembly”; then the “front panel assembly” is lifted up disengaging its U-shaped sections, Item 18A of FIG. 10A, from the “tray” ears, Item 20A of FIG. 10A.

To reassemble the “drawer assembly”, first the “tray” is pushed into the “Toaster component cavity”, Item 13, until several inches before “closed door position”, next the “wire rack” is pushed in all the way inside the “Toaster component cavity”; next the bent U-shape sections, Item 18A, of the “front panel assembly” is placed inside the notch, Item 20B, on the ear, Item 20A, of “tray” locking the two pieces together. Last, the “wire rack” is pulled forward until its “bump”, Item 19A, is nestled inside the small cavity of the “front panel assembly”, Item 18D of FIG. 10B, and the slide of the “front panel assembly”, Item 18B, is lowered to lock the “front panel assembly” and the “wire rack”.

An optional feature of automatically pushing out the “drawer assembly”, Item 17, slightly at the end of the cooking period can be added to all five designs. This optional feature, “drawer assembly release mechanism”, Item 21 of FIG. 7, uses two small spring-loaded arms, to push against the inside surface of “front panel assembly”, Item 18.

The combined units create below five new products:

i. The combination of a “standard toaster” and a “standard toaster oven” creates the “Multifunction Toaster Oven”, item 25 of FIG. 2 through FIG. 7. The “toaster component”, Item 12, and “toaster oven component” of “Multifunction Toaster Oven” can be used simultaneously or one at a time.

ii. The combination of a “standard toaster” and a “standard countertop microwave oven” creates the “Multifunction Microwave Oven-A1”, Item 35 of FIG. 13.

The “toaster component”, Item 12, and the “countertop microwave oven component” of “Multifunction Microwave Oven-A1” can be used simultaneously or one at a time.

iii. The combination of a “standard toaster” and a “standard over-the-range microwave oven” creates the “Multifunction Microwave Oven-A2”, Item 36 of FIG. 14.

In order to incorporate the “toaster component”, Item 12, into a “standard over-the-range microwave oven”, the locations of the “vents/filters”, Item, and “light fixture”, Item C, on the bottom of the “standard over-the-range microwave”, Item A of FIG. 15A, are rearranged. FIG. 15B displays the new locations of the “vents/filters”, Item 37, and “light fixtures”, Item 38, after the “toaster component”, Item 12, incorporated into the “standard over-the-range microwave oven”.

The “toaster component”, Item 12, and the “over-the-range microwave oven component” of “Multifunction Microwave Oven-A2” can be used simultaneously or one at a time.

iv. The combination of a “standard toaster”, a “standard toaster oven” and a “standard countertop microwave oven” creates the “Multifunction Microwave Oven-B1”, Item 39 of FIG. 16 and FIG. 17.

In this design, standard tubular/coiled heating elements, Item 40, are incorporated in the left and right sidewalk of the “countertop microwave oven” cavity.

The “toaster component”, Item 12, the “toaster oven component” and “microwave oven component” of “Multifunction Microwave Oven-B1” can be used simultaneously, one or two at a time.

v. The combination of a “standard toaster”, a “standard toaster oven” and a “standard over-the-range microwave oven” creates the “Multifunction Microwave Oven-B2”, Item 41 of FIG. 18 and FIG. 19.

In this design, tubular/coiled heating elements, Item 42, are incorporated in the left and right sidewalk of the “over-the-range microwave oven” cavity.

The “toaster component”, Item 12, “toaster oven component” and the “microwave oven component” of “Multifunction Microwave Oven-B2” can be used simultaneously, one or two at a time.

In order to incorporate the “toaster component”, Item 12, into a “standard over-the-range microwave oven”, the locations of the “vents/filters”, Item B, and “light fixture”, Item C, on the bottom of the “standard over-the-range microwave”, Item A of FIG. 15A, are rearranged. FIG. 15B displays the new locations of the “vents/filters”, Item 37, and “light fixtures”, Item 38, after the “toaster component”, Item 12, incorporation into the “standard over-the-range microwave oven”.

### FOOTNOTES

¹ “Standard Toaster”:

A standard toaster is a small electric appliance designed to brown sliced bread by exposing it to radiant heat, thus converting it into toast. It requires counter space to rest on.

The most common household toaster is the pop-up toaster. Bread slices are inserted vertically into slots in the top of a pop-up toaster, which make toast from bread in one to three minutes by using electric heating elements, Nichrome wires. Nichrome wire is wrapped around the inner surface of a Mica sheet and both sides of each slice of bread is exposed to the heat generated by Nichrone wire. Mica sheet is used to insulate the Nichrome wire from the metal casing of slot. Toasters have a control to adjust how much the appliance toasts the bread.

² “Standard Toaster Oven”:

A standard toaster oven is a small electric oven with a removable wire rack, a removable crumb tray, a cavity and a front door hinged on the bottom. It requires counter space to rest on. It has heating elements above and below the grilling area. Toaster ovens function the same as a small-scale Conventional Oven. Toaster ovens have settings to Broil, Bake and Toast food items placed in its wire rack. Toaster ovens have Temperature controls and Timers to control cooking of food articles.

To broil, bake or toast food articles with a toaster oven, they are placed horizontally on the rack. When the cooking is done, the toaster oven shuts off automatically, if its Timer is set, or it can be manually turned off.

Most toaster ovens are significantly larger than toasters, but are capable of performing most of the functions of electric ovens, albeit on a much smaller scale.

³ “Standard Countertop Microwave Oven”:

A standard countertop microwave oven is a small kitchen appliance that requires counter space to rest on. It consists of a Magnetron, a magnetron Control Circuit, a Waveguide and a Cooking Chamber with a Turntable.

The Turntable in a “Standard Countertop Microwave Oven” starts to turn when Microwave is turned on but in this invention the consumers have a choice to turn it off if so desired.

It works by passing microwave radiation, usually at a frequency of 2450 MHz, through the food. Water, fat, and sugar molecules in the food absorb energy from the microwave beam in a process called dielectric heating. Most molecules are electric dipoles, meaning that they have a positive charge at one end and a negative charge at the other, and is therefore twisted to and fro as it tries to align itself with the alternating electric field induced by the microwave beam. This molecular movement creates heat. Microwave heating is most efficient on liquid water, and much less so on fats, sugars, and frozen water.

⁴ “Standard Over-The-Range Microwave Oven”:

A standard over-the-range microwave oven works the same as a “Standard Countertop Microwave Oven” except that it is installed above a Conventional Range to the kitchen wall and cabinet above it. On its bottom surface it has a light fixture and two vents which are used to light up the food being prepared on the stovetop and remove the fumes.

⁵ “Combine” does not mean “retrofit”. It is a brand new product.

⁶ Except for the “Standard Toaster” which is integrated into the “Standard Toaster Oven” and “Standard Microwave Ovens”. In other words, “Standard Toaster” ceases to exist.

⁷ Note that “Drawer Assembly”, Item 17, moves in and out as a single unit.

1. a toaster component, a cooking chamber for warming up, broiling, baking and toasting (i.e. preparing/cooking) of food articles such as bread, pizza, hot dog, steak, sliced egg plant, potatoes, squash, egg, pancake and cookie is incorporated horizontally and below the main cavities of a standard “countertop toaster oven”, a standard “countertop microwave oven” and a standard “over-the-range microwave oven” comprising:
(a) a toaster component cavity which is a short, deep and wide metal shell, having four steps on each, left and right, sidewalls; with front side open; houses all the required components to complete said toaster component and incorporated in the above mentioned appliances,
(b) a drawer assembly comprising:
(i) a tray, made out of solid sheet metal with multiple small perpendicular ears at its front having a small notch on top, where these ears allow the bent U-shaped sections on the front panel assembly slide over and lock the tray and the front panel assembly together;
(ii) a wire rack, comprising a number of formed and straight metal wires with a small bend (bump) in the front and center where this bump will nestled inside a small cavity in the inner part of the front panel assembly and then locked when the U-shaped slide in the front panel assembly is lowered, and,
(iii) a front panel assembly (the door), which the wire rack and the tray are perpendicularly attached to, covers said toaster component cavity's front opening during the cooking process;
the front panel assembly has multiple bent U-shaped sections at the bottom, a small horizontal cavity at the center close to top and a two prongs slide moving up or down slightly to allow the bump in the wire rack enter or exit the small cavity;
lowering the slide when the wire rack bump is nestled inside locks the two pieces together; the slide is held by shoulder screws which secure the slide while allow its vertical movement;
the wire rack is the place that the food items are placed for cooking and tray is where the food particles and liquid (i.e. bread crumbs, meat juice/fat, pizza sauce/melted cheese, etc.) get collected; the wire rack and tray are perpendicularly attached to the front panel and this assembly slides in and out of the toaster component cavity as a single unit on the steps in the toaster component cavity side walls to prevent said food particles and liquids from dropping and spilling on the counter; the drawer panel closes the front opening of the toaster component cavity when the drawer assembly is pushed all the way in;
the drawer assembly can be disassemble and reassemble without any tools for cleaning the tray or switching the wire rack with a griddle plate by pulling out drawer assembly several inches from closed position, pulling up the slide and pushing the wire rack all the way in followed by lifting the front panel assembly which disengages its bent U-shaped section from the tray ears which leaves either the tray or the wire rack easy to be pulled out;
to reassemble the front panel assembly the tray is pushed into the toaster component cavity until several inches before reaching the end, then wire rack is pushed into the toaster component cavity all the way in; the front panel assembly is then lowered onto the tray ears until its bent U-shaped sections slide onto the tray ears and rest; the wire rack is then pulled forward until its bump nestles inside the small cavity on the inner surface of the front panel assembly; the tray and the front panel assembly will lock together when slide on the front panel assembly is lowered in place;
(c) a top heat source, comprising standard toaster's heating element, nichrome wire, and standard insulating material, mica sheet, where nichrome wire is wrapped around the bottom surface of a large mica sheet with proper and equal spacing between each run and then assembled to the ceiling of the toaster component cavity, directly above the drawer assembly's wire rack; the top heat source extends from the front to the back wall and from the right sidewall to the left sidewall of the toaster component cavity to distribute heat evenly throughout the cavity duplicating the heat distribution of a standard toaster; the mica sheet prevents nichrome wire to contact metal ceiling of the toaster component cavity.
(d) a bottom heat source, comprising standard toaster's heating element, nichrome wire, and standard insulating material, mica sheet, and a rectangular metal frame, where nichrome wire is wrapped around the top surface of a rectangular metal frame with proper and equal spacing between each run and insulated by stripes of mica; the mica stripes prevents nichrome wire to contact metal frame of the bottom heat source; the thin and narrow size and the spacing between each run of the nichrome wire allows the food particles and liquid to pass through the bottom heat source; the bottom heat source is positioned under the drawer assembly's wire rack and above its tray which allows the food particles and liquid to pass through and get collected in the tray; the bottom heat source extends from the front to the back and from the right sidewall to the left sidewall of the toaster component cavity to distribute heat evenly throughout the cavity duplicating the heat distribution of a standard toaster; and,
(e) a drawer assembly release mechanism, comprising two small electro-mechanical spring loaded arms located on the lower part of left and right sides of the toaster component, pushing against the inner surface of the front panel of drawer assembly causing it to slightly open at the end of cooking cycle.

2. A standard countertop toaster oven which has been modified to include the toaster component of claim 1, where said toaster component is incorporated horizontally and below the toaster oven cavity and allows cooking of said food items independent of the toaster oven; the resulting multifunction product replaces a standard countertop toaster oven and a standard toaster without sacrificing the utility, full functionality, full capacity, ease of use, appearance⁶ and safety of any of the two replaced appliances.

3. A standard countertop microwave oven which has been modified to include the toaster component of claim 1, where said toaster component is incorporated horizontally and below the microwave oven cavity and allows cooking of said food items independent of the said microwave oven; the resulting multifunction product replaces a standard countertop microwave oven and a standard toaster without sacrificing the utility, full functionality, full capacity, ease of use, appearance⁶ and safety of any of the two replaced appliances.

4. A standard over-the-range microwave oven which has been modified to include the toaster component of claim 1, where said toaster component is positioned horizontally and below the over-the-range microwave oven cavity and allows cooking of said food items independent of the said microwave oven; the modification also includes removing the existing light fixture from the center of the bottom surface of said microwave and replacing it with two narrow light emitting diode, LED, light fixtures and position them equally distanced from the center to the right and the left;
the resulting multifunction product replaces a standard over-the-range microwave oven and a standard toaster without sacrificing the utility, full fimctionality, full capacity, ease of use, appearance⁶ and safety of any of the two replaced appliances.

5. The cooking appliance of claim 3, which has been further modified to include the function of a standard toaster oven, further comprising two heating elements mounted to its left and right sidewalls to enable it to perform cooking of the larger food items in its microwave cavity by radiation independent of its microwave component and toaster component;
the resulting multifunction product replaces a standard countertop microwave oven, a standard toaster oven and a standard toaster without sacrificing the utility, full functionality, full capacity, ease of use, appearance⁶ and safety of any of the three replaced appliances.

6. The cooking appliance of claim 4, which has been further modified to include the function of a standard toaster oven, further comprising two heating elements mounted to its left and right sidewalls to enable it to perform cooking of the larger food items in its microwave cavity by radiation independent of its microwave component and toaster component;
the resulting multifunction product replaces a standard over-the-range microwave oven, a standard toaster oven and a standard toaster without sacrificing the utility, full functionality, full capacity, ease of use, appearance⁶ and safety of any of the three replaced appliances.
